(19) United States
(12) Patent Application Publication
(10) Pub. No.: US 2010/0146723 A1
(43) Pub. Date: Jun. 17, 2010

(54) Method and apparatus for removing hardwater stains from a ceramic plumbing fixture

(76) Inventor: Gail Evita Triglia, Gardnerville, NV (US)

Correspondence Address: John W. Crosby, 1650 Highway 395, Minden, NV, 89423, US

(21) Appl. No.: 12/316,572

(22) Filed: Dec. 11, 2008

(51) Int. Cl. A47L 13/17; B08B 1/00

(52) U.S. Cl. 15/104.94; 134/42

(57) ABSTRACT

Application to the surface of a ceramic plumbing fixture of a mesh material constructed of a molded lattice of a phenolic resin containing aluminum oxide is disclosed. The mesh can be a flat, flexible sheet, having flat or shaped contours on surfaces of the members of the mesh that are applied to the finish of the ceramic fixture. By pressing the sheet against the surface of the fixture and rubbing the sheet in a scrubbing motion, the flexible nature of the lattice provides more flexibility than sandpaper and also provides fingertip-controlled application of the abrasion of the lattice surface to the surface of the fixture.

### FIELD

The present invention relates broadly to the field of janitorial service. Specifically, the present invention relates to the removal of hard water deposits from ceramic plumbing fixtures. More specifically, the present invention relates to removing hard water deposits from toilets.

### BACKGROUND OF THE INVENTION

In the janitorial world, cleaning of ceramic fixtures commonly found in rest rooms, such as toilets and urinals, present a problem as such fixtures are prone to hard water deposits. Water that is high in mineral content, known as hard water, leaves mineral deposits on the fixture if allowed to remain over a period of time. Plumbing fixtures that allow water to sit for long periods of time, such as sinks, bath tubs, toilets and urinals, are extremely susceptible to hard water stains where water softeners are not deployed. The best approach to preventing build of this hard water buildup of minerals is to regularly clean the fixture.

There are different approaches to cleaning hard water build up, but ultimately scrubbing is typically chosen. However, scrubbing a ceramic fixture poses a risk of scratching its glazed finish if the scrubbing material used to remove mineral deposits is too coarse. Such is the problem with commonly-used pumice stone, which quickly scratches a finish to the point that the fixture is considered damaged or requires replacement. Sandpaper is also used, with sometimes damaging results. On the opposite side of the spectrum, if the scrubbing material is too soft, it may either be ineffective or require too much effort to remove the deposit that it isn't a useful solution. Such is the case with plastic scrubbing materials, such as Scotchbrite™ pads and the like.

Thus, there is a heartfelt need for an effective way to scrub away mineral deposits without damaging ceramic plumbing fixtures.

### SUMMARY OF THE INVENTION

The present invention solves the problem above by applying to the surface of a ceramic plumbing fixture a mesh material constructed of a molded lattice of a phenolic resin containing aluminum oxide giving the surface of the lattice a grit of 150 to 180. The mesh can be a flat, flexible sheet, having flat contours on surfaces of the members of the mesh that are applied to the finish of the ceramic fixture. By pressing the sheet against the surface of the fixture and rubbing the sheet in a scrubbing motion, be it circular, back and forth, side to side, up and down, and the like, the flexible nature of the lattice provides more flexibility than sandpaper and also provides fingertip-controlled application of the abrasion of the lattice surface to the surface of the fixture, thus effectively removing mineral deposits. The inventor has found that a mesh of about 180 works effectively in the preferred embodiment.

Many features and advantages of the present invention will become apparent to one skilled in the art upon reading the following detailed description, when considered in conjunction with the following drawings, in which:

### BRIEF DESCRIPTION OF THE DRAWINGS

FIG. 1 shows the mesh of resin and abrasive material used in the method of the present invention.

FIG. 2 shows a profile of an elongated member of the mesh shown in FIG. 1.

FIG. 3 shows an alternative profile of an elongated member that can be used in the construction of the mesh shown in FIG. 1.

FIG. 4 shows a glove containing a mesh as shown in FIG. 1.

FIG. 5 shows the mesh of FIG. 1 applied to a scouring pad having a plastic scrubbing material on one side of the mesh.

FIG. 6 shows the mesh of FIG. 1 applied around a grippable pumice stone.

### DETAILED DESCRIPTION OF THE DRAWINGS

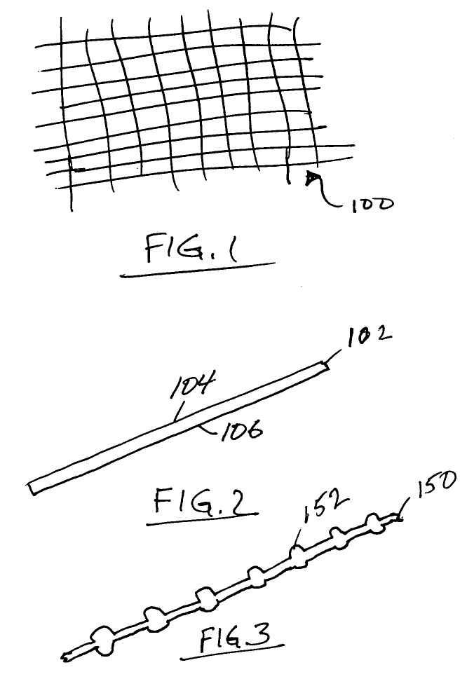

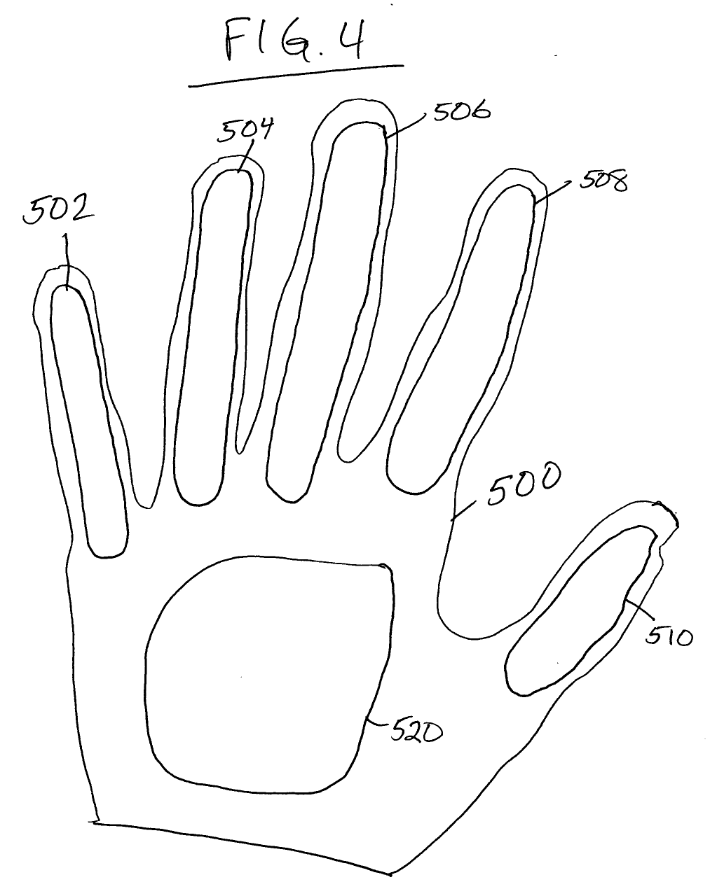

Directing attention to FIG. 1, there is shown mesh 100 of a flexible, poured material. The poured material is in the preferred embodiment a phenolic resin, but other materials that are elastic can be used. Mesh 100 has an abrasive component, such as aluminum oxide polymer impregnated with an abrasive powder, such as aluminum oxide, that brings the surface of its elongated members to a grit of approximately 150-180. Mesh 100 is constructed from elongated members 102 placed in a screen arrangement, defining holes in the mesh of a frequency of about 180 openings per square inch. Obviously, FIG. 1 is not drawn to scale and shows a much smaller number of larger openings per square inch. Elongated member 102 is shown in FIG. 2 as having a generally rectangular profile, defining four surfaces. Top surface 104 and bottom surface 106 are exposed to one of the two sides of mesh 100, and come into contact with the ceramic fixture in a scrubbing motion.

For non-phenolic resin embodiments, As shown in FIG. 3, elongated member 150 may contain beads 152 that, depending on pressure applied, can flatten, thus providing increased surface contact for increased scrubbing requirements.

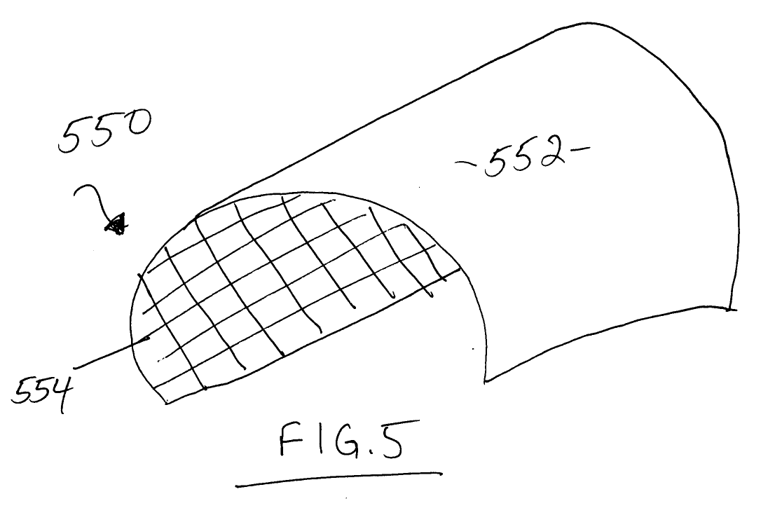

FIG. 4 illustrates the application of mesh 100 to glove 500. By arranging portions of mesh 100 in areas 502, 504, 506, 508, 510, and 520, glove 500 is a useful applicator of mesh 100.

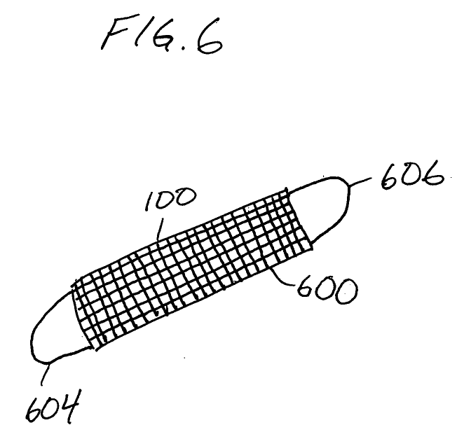

FIG. 5 illustrates a combination scrubbing pad 550 that contains a plastic scrubbing material on side 552, and mesh 100 on opposite side 554. This embodiment is useful for a cautious approach to scrubbing mineral deposits from ceramic fixtures.

A more aggressive approach to removing mineral deposits can be utilized with an embodiment of the present invention shown in FIG. 6. Scrubbing stone 600 includes mesh 100 wrapped around a pumice stone so that only ends 604, 606 of the pumice stone are exposed. In this manner, if mesh 100 does not effectively remove the mineral deposit, light application of the pumice stone can provide an increased measure of abrasion to the fixture surface.

While there has been described and illustrated herein in detail the preferred embodiment of the present invention, it is to be understood that numerous modifications can be made to the various embodiments of the present invention without departing from the spirit thereof.

What is claimed is:

1. A method of cleaning a ceramic plumbing fixture, comprising:
providing a mesh having an abrasive element contained mixed therein define a grit of at least 150 on at least one side of the mesh;
rubbing the mesh on a surface of a ceramic containing mineral deposits in at least one of the motions of the group consisting of side-to-side, up-and-down, substantially circular, and substantially arcuate.

2. An apparatus for removing mineral deposits from a ceramic plumbing fixture, comprising:
a scrubbing pad having first and second opposing sides, wherein the first side has a plastic scrubbing material, and the second side has a mesh having an abrasive element that defines a surface on the mesh of at least 150 grit.
